(19) United States
(12) Patent Application Publication
(10) Pub. No.: US 2021/0232006 A1
(43) Pub. Date: Jul. 29, 2021

(54) DISPLAY PANEL AND DISPLAY DEVICE

(71) Applicant: HKC CORPORATION LIMITED, Shenzhen (CN)

(72) Inventor: PEI HSIN LIN, Chongqing (CN)

(21) Appl. No.: 16/311,671

(22) PCT Filed: Dec. 4, 2018
(86) PCT No.: PCT/CN2018/119082

§ 371 Date: Dec. 19, 2018

(30) Foreign Application Priority Data
Nov. 26, 2018 (CN) 201811412590.3

(51) Int. Cl. G02F 1/1362; G02F 1/1333; G02F 1/1335; G02F 1/1343; G02F 1/1339

(52) U.S. Cl. CPC G02F 1/136209; G02F 1/133302; G02F 1/136222; G02F 1/133308; G02F 1/134309; G02F 1/13394; G02F 1/13396; G02F 1/133528

(57) ABSTRACT

The present application discloses a display panel and a display device. The display panel includes a first substrate, a second substrate opposite to the first substrate, and a light shielding layer configured to shield a non-display region of the display panel, where the light shielding layer is located outside the first substrate or the second substrate.

The present application claims priority to the Chinese Patent Application No. CN201811412590.3, filed to the Chinese Patent Office on Nov. 26, 2018, and entitled “DISPLAY PANEL AND DISPLAY DEVICE”, which is incorporated herein by reference in its entirety.

### TECHNICAL FIELD

The present application relates to the technical field of display, and in particular, to a display panel and a display device.

### BACKGROUND

The statements herein merely provide background information related to the present application and do not necessarily constitute the prior art.

A liquid crystal display has man advantages such as a thin body power saving, and no radiation, and thus has been widely used. Most liquid crystal displays currently available on the market are backlight liquid crystal displays, which include a liquid crystal panel and a backlight module. The working principle of the liquid crystal panel is to place liquid crystal molecules in two parallel glass substrates, and apply a driving voltage on the two glass substrates to control the rotation directions of the liquid crystal molecules to refract the light of the backlight module so as to generate a picture.

In order to increase the aperture ratio of the liquid crystal panel and reduce the production cost, an array substrate known to the applicant employs a Black Photo Spacer (BPS) technology that is, a Black Matrix (BM) and a Photo Spacer (PS) are thrilled by a photolithography process. However, because the bezel of the display panel is designed as a large area, the height of the bezel BM in the BPS technology is relatively difficult to control, and it is easy to make the bezel relatively high, and as a result, it causes uneven thickness, resulting in poor display of the panel.

### SUMMARY

The technical problem to be solved by the present application is to provide a panel and a display deuce that avoid pool display of the panel caused by uneven thickness of a BM.

To achieve the foregoing objective, the present application provides a display panel, including: a first substrate; a second substrate opposite to the first substrate; and a light shielding layer configured to shield a non-display region of the display panel and located outside the first substrate or the second substrate.

Optionally the first substrate includes a first glass layer and a color resistance laver; the color resistance layer includes at least two color resistances; the color resistance layer is provided in a first direction of the fast glass layer, facing the second substrate; the light shielding layer is located on the surface of the first glass layer.

Optionally, the first glass layer includes a display region and a bezel region; the bezel region is located on both sides of the display region; the light shielding layer includes a first BM and a second BM; the first BM is located in the bezel region, and the second BM is located in the display region and between two connecting color resistances.

Optionally, the first substrate includes a first polarizing plate; the first polarizing plate is located in a second direction of the first glass layer; the light shielding layer is located on the surface of the first polarizing plate.

Optionally the second substrate includes a second glass layer and a common electrode layer; the common electrode layer is provided on the second glass layer, facing, the first substrate; the light shielding layer is located on the surface of the second glass layer.

Optionally the second glass layer includes a display region and a bezel region; the bezel region is ideated on both sides of the display region; the light shielding layer includes a first BM and a second BM; the first BM is located in the bezel region and the second BM is located in the display region.

Optionally, the second substrate includes a second polarizing plate; the second polarizing plate is located in a first direction of the second glass layer, facing the first substrate; and the light shielding layer is located on the surface of the second polarizing plate.

Optionally the light shielding layer is located outside the first substrate and the second substrate.

Optionally the display panel further includes a liquid crystal box and a plastic frame;
the first substrate includes a first glass layer, an active switch array layer, a color resistance layer, a pixel electrode layer, a driving circuit, and a first polarizing plate;
the first glass layer is located on an inner surface of the first polarizing plate; the active switch array layer and the driving circuit are located on an inner surface of the first glass layer; the color resistance layer is located on an inner surface of the active switch array layer; and the pixel electrode layer is located on an inner surface of the color resistance layer;
the second substrate includes a second polarizing plate, a second glass layer, a common electrode layer, a main support interval and a sub-support interval;
the second glass layer is located on an inner surface of the second polarizing plate; the main support interval and the sub-support interval are located on an inner surface of the second glass layer; and the common electrode layer is located at the inner surfaces of the second glass layer, the main support interval and the sub-support interval; and
the first substrate and the second substrate are distributed opposite to each other; the liquid crystal box and the plastic frame are arranged between the first substrate and the second substrate; the plastic frame is located at two ends of the first substrate and two ends of the second substrate, and seals the liquid crystal box between the first substrate and the second substrate.

A display panel, including:
a first substrate;
a second substrate opposite to the first substrate; and
a light shielding layer configured to shield a non-display region of the display panel and located outside the first substrate or the second substrate;
the first substrate includes a first glass layer and a color resistance layer; the color resistance layer includes at least two color resistances; the color resistance layer is provided in a first direction of the first glass layer, facing the second substrate; the lit shielding layer is located on the surface of the first glass layer;
the first glass layer includes a display region and a bezel region, and the bezel region is located on both sides of the display region;
the light shielding layer includes a first BM and a second BM; the first BM is located in the bezel region, and the second BM is located in the display region and between two connecting color resistances;
the display panel thither includes a liquid crystal box and a plastic frame;
the first substrate includes a first glass layer, an active switch array layer, a color resistance layer, a pixel electrode layer; a driving circuit, and a first polarizing plate;
the first glass layer is located in a first direction of the first polarizing plate; the active switch array layer and the driving circuit are located in a first direction of the first glass layer; the color resistance layer is located in a first direction of the active switch array layer; and the pixel electrode layer located in a first direction of the color resistance layer;
the second substrate includes a second polarizing plate, a second glass layer, a common electrode layer, a main support interval and a sub-support interval,
the second glass layer is located in a second direction of the second polarizing plate; the main support interval and the sub-support interval are located in a second direction of the second glass layer; and the common electrode layer is located in the second directions of the glass layer, the main support interval and the sub-support interval;
the first substrate and the second substrate are distributed opposite to each other; a liquid crystal box and a plastic frame are provided between the first substrate and the second substrate; and the plastic frame is located at two ends of the first substrate and two ends of the second substrate and seats the liquid crystal box between the first substrate and the second substrate.

The present application further discloses a display device, including the foregoing display panel and a control circuit for controlling the display panel.

If the light shielding layer is processed together with the support intervals between the first substrate and the second substrate, the height thereof is difficult to control, so the light shielding layer is provided outside the first substrate or the second substrate, the portion that is easily manufactured and controlled between the first substrate and the second substrate is directly processed, so as to prevent the occurrence of the phenomena of uneven thickness of a film layer and poor display effect.

### BRIEF DESCRIPTION OF DRAWINGS

The drawings are included to provide further understanding of embodiments of the present application, which constitute a part of the specification and illustrate the embodiments of the present application, and describe the principles of the present application together with the text descriptions. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic diagram of a process architecture of an SOC display screen;

FIG. 2 is a schematic diagram of a process architecture of a GOA display screen;

FIG. 3 is a schematic diagram of a processing flow of a BM and a support interval;

FIG. 4 is a schematic diagram of a BPS processing flow;

FIG. 5 is a side vie of an LCD module architecture of a GOA in COT+BPS;

FIG. 6 is a side view of a segment gap of an LCD module architecture of a GOA in COT+BPS;

FIG. 7 is a side view of a module architecture in which a light shielding layer is provided outside a first glass plate according to an embodiment of the present application;

FIG. 8 is a side view of a segment gap module architecture in which a light shielding layer is provided outside a first glass plate according to an embodiment of the present application;

FIG. 9 is a side view of a module architecture in which a light shielding layer is provided outside a first polarizing plate according to an embodiment of the present application;

FIG. 10 is a side view of a module architecture in which a light shielding layer is provided outside the second glass layer according to an embodiment of the present application;

FIG. 11 is a side view of a module architecture in which a light shielding layer is provided outside a second polarizing plate according to an embodiment of the present application;

FIG. 12 is a side view of a module architecture in which a light shielding layer is provided outside a first substrate and a second substrate according to an embodiment of the present application; and

FIG. 13 is a schematic diagram of a display device according to an embodiment of the present application.

### DETAILED DESCRIPTION

The specific structure and faction details disclosed herein are merely representative, and are intended to describe exemplary embodiments of the present application. However, the present application can be specifically embodied in many alternative forms, and should not be interpreted to be limited to the embodiments described herein.

In the description of the present applications, it should be understood that, orientation or position relationships indicated by the terns “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms such as “first” and “second” are merely for a descriptive purpose, and cannot be understood as indicating or implying a relative importance, or implicitly indicating the number of the indicated technical features. Hence, the features defined by “first” and “second” can explicitly or implicitly include one or more features. In the description of the present application, “a plurality of” means two or more, unless otherwise stated. In addition, the term “include” and ally variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or electrically connected; or directly connected or indirectly connected through an intermediate medium, or in an internal communication between two elements. The specific meanings about the foregoing terms in the present application may be understood by those skilled in the art according to specific circumstances.

Unless otherwise specified, the “first direction” in the present application is a direction pointing to the interior of a display panel; and the “second direction” is a direction pointing to the exterior of the display panel.

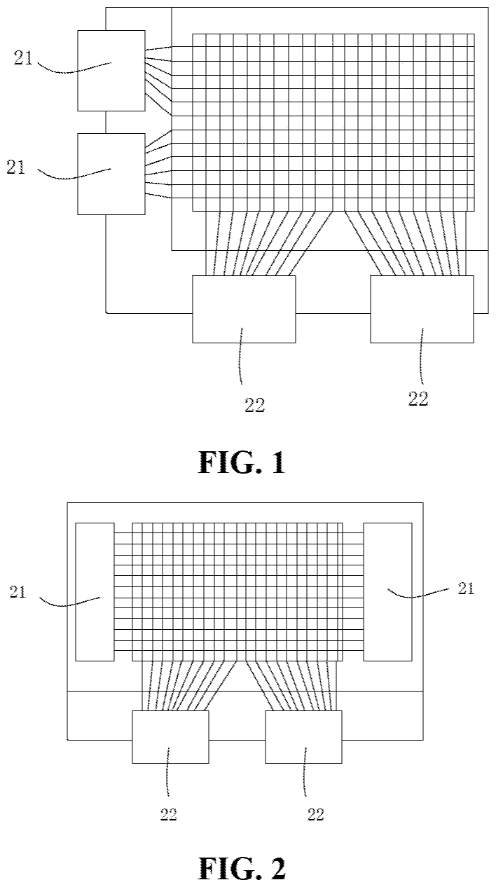

As shown in FIGS. 1-6, the process architecture of a display screen is divided into a System on Chip (SOC) and a Gate Driver on Array (GOA) according to a to driver design. From the perspective of product demand, the smaller the bezel is, as anyone expects, and therefore, relative to the design of the SOC, the GOA has a smaller bezel. The GOA is an important technology in the panel design and has the main advantages that the GOA can eliminate a gate driver IC and reduce the cost. Therefore, a GOA product is bound to be a mainstream trend in the future.

More and more LC panels use bezel-free displays, because a bezel-free picture produces an immersive feeling, a bezel-free technology is slowly accepted by consumers, because of new viewing experience, the bezel-free display has gradually become a new direction of development!

However, a color filter on TFT (COT) that a color resistance module is manufactured on a lower plate, rather than the traditional process of manufacturing a color resistance on an upper plate, and thus, the aperture ratio of the pixel can be increased, and the probability of occurrence of uneven brightness can be reduced. Therefore, the products of COT+GOA are bound to be the mainstream trend in the future.

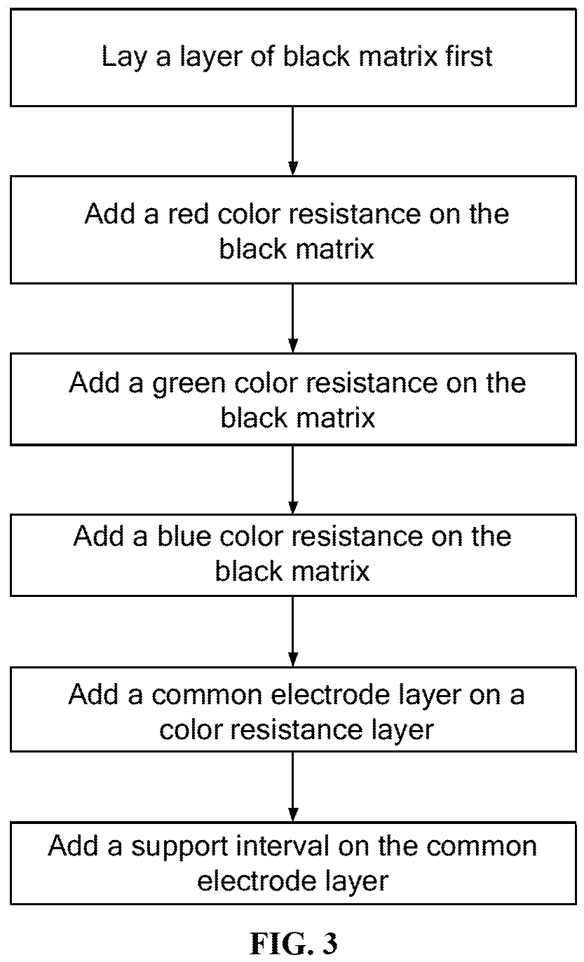

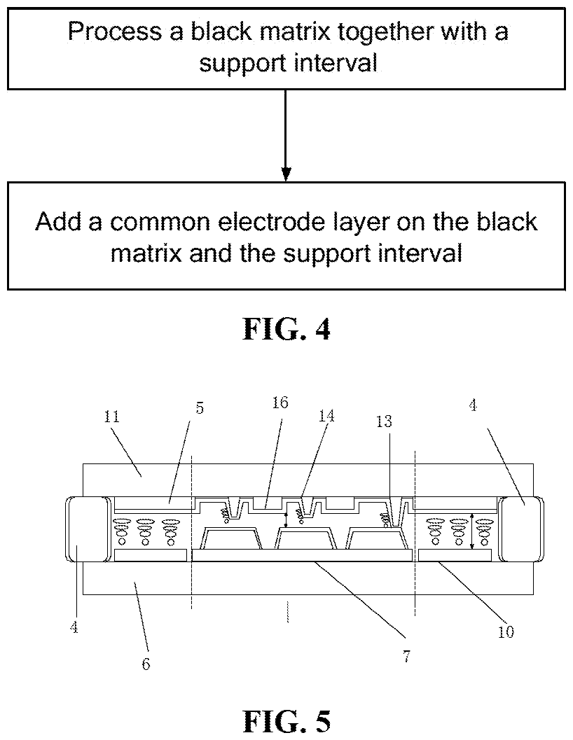

A BPS manufacture procedure is BM and PS manufacture procedures, and a manufacture procedure known to the inventor is as shown in FIG. 3, and the design of a color film substrate can be completed only by two manufacture procedures and six processes. Another manufacture procedure known to the inventor combines the two manufacture procedure into one, which saves the cost of the manufacture procedures, as shown in the process flow in FIG. 4.

FIG. 5 is an LCD module architecture of the GOA of the COT+BPS, it can be seen from FIG. 5 that upper glass and lower glass are filled with LCs, and the periphery thereof is sealed with a plastic frame made of a sealing material. Therefore, the GOA is full of LC thereon.

The BPS manufacture procedure is BM and PS manufacture procedures, which are combined into one manufacture procedure of BM+PS; however, the PS is divided into a main support interval (Main-PS) and a sub-support interval (Sub-PS), so it can be seen that there are two segment gaps of the BM, which are X and Y, respectively, where Main PS−Sub PS=Y, Sub PS−BM=X.

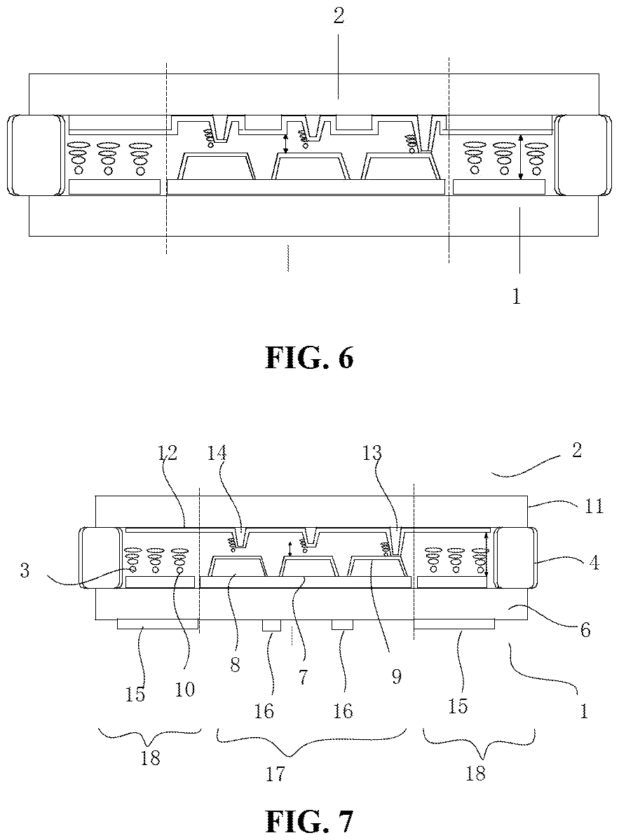

Referring to FIG. 6, the bezel-free COT+BPS products available on the market all challenge how to use a translucent mask to make two kinds of the segment gaps X and Y, further, because the bezel is designed to be a large area, the height of a bezel BM is difficult to control and iris easy to make the bezel relatively high, and therefore, it is easy to cause uneven brightness. Therefore, how to use a semi-transmissive mask to make BM+Main PS+Sub PS (the two kinds of segment gaps X and Y) without uneven brightness becomes a frequently challenged topic.

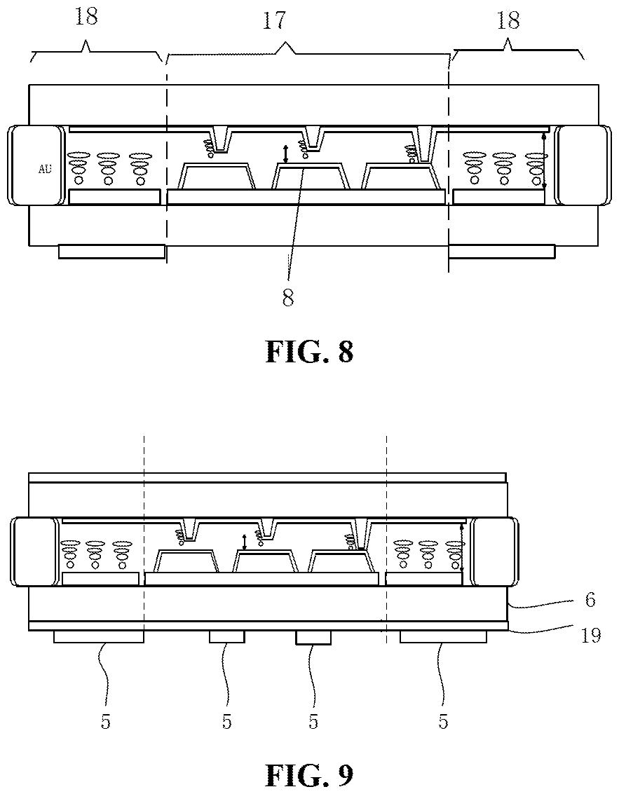

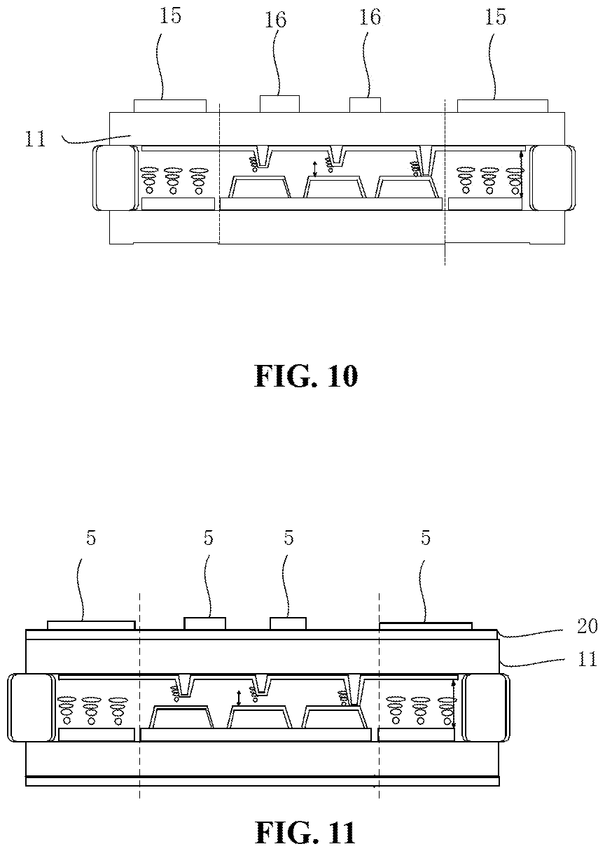

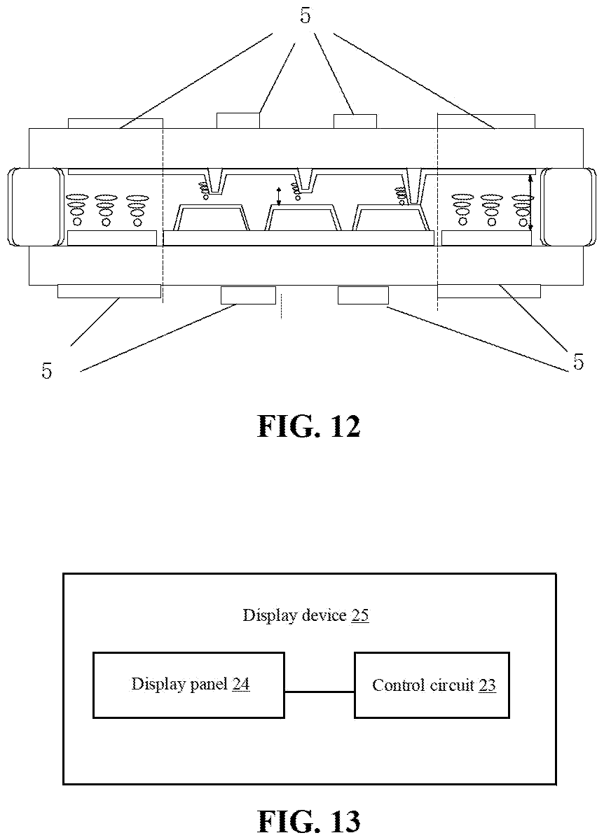

An embodiment of the present application discloses a display panel; referring to FIG. 7-FIG. 12, the display panel includes a first substrate 1, a second substrate 2 opposite to the first substrate 1, and a light shielding layer 5 configured to shield a non-display region 18 of the display panel and located outside the first substrate 1 or the second substrate 2.

In this embodiment, when the light shielding layer 5 is processed together with a support interval between the first substrate 1 and the second substrate 2, the height thereof is difficult to control, so the light shielding layer 5 is provided outside the first substrate 1 or the second substrate 2; if the portion which is easily produced and controlled between the first substrate 1 and the second substrate 2 is directly processed, the phenomena of uneven thickness of a film layer and poor display effect will not occur.

Optionally, in this embodiment, the first substrate 1 includes a first glass layer 6 and a color resistance layer 8; the color resistance layer 8 includes at least two color resistances; the color resistance layer 8 is provided on one side of the first glass layer 6, facing the second substrate 2; the light shielding layer 5 is located on the surface of the first glass layer 6.

In this embodiment, the light shielding layer 5 outside the first glass layer 6 absorbs external light, thereby preventing the external light from entering the display panel and causing the phenomenon of the uneven brightness.

Optionally, in this embodiment, the first glass layer 6 includes a display region 17 and a bezel region 18; the bezel region 18 is located at two sides of the display region 17; the light shielding layer 5 includes a first BM 15 located in the bezel region 18; the light shielding layer 5 further includes a second BM 16 located in the display legion 17 and between the two connecting color resistances.

In this embodiment, the area of the light shielding layer 5 of the bezel region 18 is relatively large, and it is difficult to maintain the overall height consistent during processing, therefore, the light shielding layer 5 of the bezel region 18 can be provided outside the glass, so that the support interval of the display region 17 and the region of the BM are relatively small, the thickness thereof is uniform, and the display effect is better; the second BM 16 in the middle of the support interval is provided on the display region 17 outside the first glass layer 6, so that the support interval between the first substrate 1 and the second substrates 2 can be directly made by rising a mask, and then all the light shielding layers 5 are directly provided outside the first glass layer 6, so that the processing is convenient and time-saving; further, the second BM 16 is located between the two connecting color resistances, which hence does not of the display effect of the panel.

Optionally, in this embodiment, the first substrate 1 includes a first polarizing plate 19; the first polarizing plate 19 is located in the second direction of the first glass layer 6, and the light shielding layer 5 is located on the surface of the first polarizing plate 19.

In this embodiment, the light shielding layer 5 is provided on the surface of the first polarizing plate 19, which does not affect the component on the first substrate 1; if the light shielding layer 5 is provided inside the first substrate 1, the light shielding layer 5 may be extruded, in addition, other structures on the first substrate 1 are not closely attached, which affects the overall effect of the first substrate 1; if the light shielding layer 5 is provided outside the first polarizing plate 19, the light shielding layer 5 will not be extruded or damaged, and does not affect other structural parts of the first substrate 1.

Optionally, in this embodiment, the second substrate 2 includes a second glass layer 11 and a common electrode layer 12; the common electrode layer 12 is provided on the second glass layer 2, facing the first substrate 1, and the light shielding layer 5 is located at the sure of the second glass layer 11.

In this embodiment, after the light emitted, by a backlight source is absorbed by the light shielding layer 5 outside the second glass layer 11, the remaining light directly passes through the color resistance layer 8, and no light passes through other parts except for the color resistance layer 8, so that light leakage can be resolved from a root cause.

Optionally, in this embodiment, the second glass layer 11 includes a display region 17 and a bezel region 18; the bezel region 18 is located at two sides of the display region 17; the light shielding layer 5 includes a first BM 15 and a second BM 16; the first BM 15 is located in the bezel region 18; and the second BM 16 is located in the display region 17.

In this embodiment, the area of the light shielding layer 5 of the bezel region 18 is relatively large, and it is difficult to maintain the overall height consistent during the processing, therefore, the light shielding layer 5 of the bezel region 18 can be provided outside the glass, so that the area of the support interval of the display region 17 and the area of the BM are relatively on the thickness thereof is uniform, and the display effect thereof is better; the light shielding layer 5 in the middle of the support interval is provided on the display region 17 outside the second glass layer 11, so that the support interval between the first substrate 1 and the second substrate 2 can be directly made by using the mask; all the light shielding layers 5, including the light shielding layers 5 of the display region 17 and the bezel region 18, are then made directly outside the second glass layer 11, which is convenient to process and saves time.

Optionally, in this embodiment, the second substrate 2 includes a second polarizing plate 20, the second polarizing plate 20 is located in a first direction of the second glass layer 11, and the light shielding layer 5 is located at the surface of the second polarizing plate 2.

In this embodiment, the light shielding layer 5 is provided on the surface of the second polarizing plate 20, which can prevent the second substrate 2 from causing extrusion and damage loss on the second polarizing plate 20, and increase the service life of the light shielding plate 5.

Optionally, in this embodiment the light shielding layer 5 is located outside the first substrate 1 and the second substrate 2.

In this embodiment, double shielding effects are provided, the light shielding layer 5 outside the first substrate 1 absorbs the external light, preventing the external light from entering the display panel and causing the phenomenon of the uneven brightness; and the light shielding layer 5 outside the second substrate 2 absorbs the light that does not pass through the color resistance layer 8, and the double light shielding effects make the display panel more stable.

Optionally in this embodiment, the display panel further includes a liquid crystal box 3 and a plastic frame 4.

The first substrate 1 includes a first glass layer 6, an active switch array layer 7, the color resistance layer 8, a pixel electrode layer 9, a driving circuit 10 and a first polarizing plate 19.

The first glass layer 6 is located in the first direction of the first polarizing plate 19, the active switch array layer 7 and the driving circuit 10 are located in the first direction of the first glass layer 6, the color resistance layer 8 is located in the first direction of the active switch array layer 7, and the pixel electrode layer 9 is located in the first direction of the color resistance layer 8.

The second substrate 2 includes a second polarizing plate 20, a second glass layer 11, a common electrode layer 12, a main support interval 13 and a sub-support interval 14.

The second glass layer 11 is located in the second direction of the second polarizing plate 20, the main support interval 13 and the sub-support interval 14 are located in the second direction of the second glass layer 11, the main support interval 13 and the sub-support interval 14 are evenly distributed, the common electrode layer 12 is located in the second directions of the second glass layer 11, the main support interval 13 and the sub-support interval 14.

The fast substrate 1 and the second substrate 2 are distributed opposite to each other; the liquid crystal box 3 and the plastic frame 4 are arranged between the first substrate 1 and the second substrate 2; and the plastic frame 4 is located at two ends of the first substrate 1 and two ends of the second substrate 2 and seals the liquid crystal box 3 between the first substrate 1 and the second substrate 2.

In this embodiment, if the light shielding layer is processed together with the support interval between the first substrate and the second substrate, the height thereof is difficult to control, so the light shielding layer is provided outside the first substrate or the second substrate, so that the BPS portion inside the substrate and the second substrate only needs to be provided with the main support interval and the sub-support interval, and only one segment gap is provided there between, so only two support intervals with a small height and a small region are processed, so that the phenomena of uneven thickness of a Jim Dryer and poor display effect will not occur.

As another embodiment of the present application, with reference to FIGS. 7-12, the present application further discloses a display panel, including:

a first substrate 1, a second substrate 2 opposite to the first substrate 1, and a light shielding layer 5 configured to shield a non-display region 18 of the display panel and located outside the first substrate 1 or the second substrate 2.

The first substrate 1 includes a first glass layer 6 and a color resistance layer 8; the color resistance layer includes at least two color resistances; the color resistance layer is provided in the first direction of the first glass layer 6, facing the second substrate 2; the first glass layer 6 includes a display region 17 and a bezel region 18; the bezel region 18 is located on both sides of the display region 17; the light shielding layer 5 includes a first BM 15 and a second BM 16; the first BM 15 is located in the bezel region 18, and the second BM 16 is located in the display region 17 and between the two connecting color resistances.

The display panel further includes a liquid crystal box 3 and a plastic frame 4.

The first substrate 1 includes an active switch array, layer 7, a color resistance layer 8, a pixel electrode layer 9 a driving circuit 10, and a first polarizing plate 19; the first polarizing plate 19 is located in the second direction of the first substrate 1; the first glass layer 6 is located in the first direction of the first polarizing plate 19; the active switch array layer 7 and the driving circuit 10 are located in the first direction of the first glass layer 6; the color resistance layer 8 is located in the first direction of the active switch array layer 7; and the pixel electrode layer 9 is located in the first direction of the color resistance layer 8.

The second substrate 2 includes a second polarizing plate 20, a second glass layer 11, a common electrode layer 12, a main support interval 13 and a sub-support interval 141 the second polarizing plate 20 is located in the first direction of the second substrate 2; the second glass layer 11 is located in the second direction of the second polarizing plate 20; the main support interval 13 and the sub-support interval 14 are located in the second direction of the second glass layer 11, and are evenly distributed; the common electrode layer 12 is located in the second directions of the second glass layer 11, the main supporting spacing 13 and the sub-support interval 14.

The first substrate 1 and the second substrate 2 are distributed opposite to each other; a liquid crystal box 3 and a plastic frame 4 are arranged between the first substrate 1 and the second substrate 2; the plastic frame 4 is located at two ends of the first substrate 1 and two ends of the second substrate 2 and seals the liquid crystal box 3 between the first substrate 1 and the second substrate 2.

As another embodiment of the present application, referring to FIG. 13, the present application further discloses a display device 25 including the foregoing display panel 24 and a control circuit 23 for controlling the display panel 24.

The panel of the present application may be a Twisted Nematic (TN) panel, an In-Plane Switching IPS) panel, and a Multi-domain Vertical Alignment (VA) panel, and of course, can also be other types of panels, if appropriate.

The above content is a detailed description of the present application in conjunction with the specific embodiments, and the special implementation of the present application is not limited to the description. It will be apparent to a person of ordinary skill in the art that a plurality of simple deductions or replacements can be made without departing from the spirit of the present application, and should be considered to fall into the scope of protection of the present invention.

What is claimed is:

1. A display panel, comprising:
a first substrate;
a second substrate opposite to the first substrate; and
a light shielding layer configured to shield a non-display region of the display panel;
the light shielding layer is located outside the first substrate or the second substrate.

2. The display panel according to claim 1, wherein the first substrate comprises a first glass layer and a color resistance layer; the color resistance layer comprises at least two color resistances; the color resistance layer is provided in a first direction of the first glass layer, facing the second substrate; and the light shielding layer is located on the surface of the first glass layer.

3. The display panel according to claim 2, wherein the first glass layer comprises a display region and a bezel region; the bezel region is located on both sides of the display region; the light shielding layer comprises a first black matrix and a second black matrix; the first black matrix is located in the bezel region, and the second black matrix is located in the display region and between two connecting color resistances.

4. The display panel according to claim 2, wherein the first substrate comprises a first polarizing plate; the first polarizing plate is located in a second direction of the first glass layer, facing away from the second substrate; the light shielding layer is located on the surface of the first polarizing plate.

5. The display panel according to claim 1, wherein the second substrate comprises a second glass layer and a common electrode layer; the common electrode layer is provided on the second glass layer, facing the first substrate, the light shielding layer is located on the surface of the second glass layer.

6. The display panel according to claim 5, wherein the second glass layer comprises a display region and a bezel region; the bezel region is located on both sides of the display region; the light shielding layer comprises a first black matrix and a second black matrix; the first black matrix is located in the bezel region; and the second black matrix is located in the display region.

7. The display panel according to claim 5, wherein the second substrate comprises a second polarizing plate; the second polarizing plate is located in a first direction of the second glass layer, facing the first substrate; the light shielding layer is located on the surface of the second polarizing plate.

8. The display panel according to claim 1, wherein the light shielding layer is located outside the first substrate and the second substrate.

9. The display panel according to claim 1, further comprising a liquid crystal box and a plastic frame;
the first substrate comprises a first glass layer, an active switch array layer, a color resistance layer, a pixel electrode layer, a driving circuit, and a first polarizing plate;
the first glass layer is located on an outer surface of the first polarizing plate, the active switch array layer and the driving circuit are located on an inner surface of the first glass layer, the color resistance layer is located on an inner surface of the active switch array layer, and the pixel electrode layer is located on an inner surface of the color resistance layer;
the second substrate comprises a second polarizing plate, a second glass layer, a common electrode layer, a main support interval and a sub-support interval;
the second glass layer is located on an inner surface of the second polarizing plate, the main support interval and the sub-support interval are located on an inner surface of the second glass layer, and the common electrode layer is located at the inner surfaces of the second glass layer, the main support interval and the sub-support interval;
the first substrate and the second substrate are distributed opposite to each other; the liquid crystal box and the plastic frame are arranged between the first substrate and the second substrate; the plastic frame is located at two ends of the first substrate and two ends of the second substrate, and seals the liquid crystal box between the first substrate and the second substrate.

10. A display panel, comprising:
a first substrate;
a second substrate opposite to the first substrate; and
a light shielding layer configured to shield a non-display region of the display panel and located outside the first substrate or the second substrate;
the first substrate comprises a first glass layer and a color resistance layer; the color resistance layer comprises at least two color resistances; the color resistance layer is provided in the first direction of the first glass layer, facing the second substrate; the light shielding layer is located on the surface of the first glass layer;
the first glass layer comprises a display region and a bezel region, and the bezel region is located on both sides of the display region;
the light shielding layer comprises a first black matrix and a second black matrix;
the first black matrix is located in the bezel region, and the second black matrix is located in the display region and between two connecting color resistances:
the display panel further comprises a liquid crystal box and a plastic frame;
the first substrate comprises a first glass layer, an active switch array layer, a color resistance layer, a pixel electrode layer, a driving circuit, and a first polarizing plate;
the first glass layer is located in a first direction of the first polarizing plate; the active switch array layer and the driving circuit are located in a first direction of the first glass layer; the color resistance layer is located in a first direction of the active switch array layer; and the pixel electrode layer is located in a first direction of the color resistance layer;
the second substrate comprises a second polarizing plate, a second glass layer, a common electrode layer, a main support interval, and a sub-support interval;
the second glass layer is located in a second direction of the second polarizing plate, facing away from the first substrate; the main support interval and the sub-support interval are located in a second direction of the second glass layer, and the common electrode layer is located in the second directions of the glass layer, the main support interval and the sub-support interval;
the first substrate and the second substrate are distributed opposite to each other; a liquid crystal box and a plastic frame are provided between the first substrate and the second substrate; the plastic frame is located at two ends of the first substrate and two ends of the second substrate and seals the liquid crystal box between the first substrate and the second substrate.

11. A display device, comprising a display panel and a control circuit, the display panel comprising:
a first substrate;
a second substrate opposite to the first substrate; and
a light shielding layer configured to shield a non-display region of the display panel;
the light shielding layer is located outside the first substrate or the second substrate:
the control circuit is configured to control the display panel.

12. The display device according to claim 11, wherein the first substrate comprises a first glass layer and a color resistance layer; the color resistance layer comprises at least two color resistances; the color resistance layer is provided in a first direction of the first glass layer, facing the second substrate; the light shielding layer is located on the surface of the first glass layer.

13. The display device according to claim 12, wherein the first glass layer comprises a display region and a bezel region, the bezel region is located on both sides of the display region; the light shielding layer comprises a first black matrix and a second black matrix; the first black matrix is located in the bezel region, and the second black matrix is located in the display region and between two connecting color resistances.

14. The display device according to claim 12, wherein the first substrate comprises a first polarizing plate; the first polarizing plate is located in a second direction of the first glass layer; and the light shielding layer is located on the surface of the first polarizing plate.

15. The display device according to claim 11, wherein the second substrate comprises a second glass layer and a common electrode layer: the common electrode layer is provided on the second glass layer, facing the first substrate; and the light shielding layer is located on the surface of the second glass layer.

16. The display device according to claim 11, wherein the second glass layer comprises a display region and a bezel region; the bezel region is located on both sides of the display region: the light shielding layer comprises a first black matrix and a second black matrix; the first black matrix is located in the bezel region; and the second black matrix is located in the display region.

17. The display device according to claim 11, wherein the light shielding layer is located outside the first substrate and the second substrate.
